(19) United States
(12) Patent Application Publication
(10) Pub. No.: US 2016/0180584 A1
(43) Pub. Date: Jun. 23, 2016

(54) VIRTUAL MODEL USER INTERFACE PAD

(71) Applicant: LUCID GLOBAL, LLC., Sarasota, FL (US)

(72) Inventors: Dale Park, Poway, CA (US); Jeff Hazelton, Sarasota, FL (US); Lawrence Kiey, Downington, PA (US)

(73) Assignee: Lucid Global, LLC.

(21) Appl. No.: 14/576,527

(22) Filed: Dec. 19, 2014

(51) Int. Cl. G06T 17/10

(52) U.S. Cl. CPC G06T 17/10; G06T 2200/04

(57) ABSTRACT

Various exemplary embodiments relate to a method and related devices including one or more of the following: displaying a three-dimensional model, wherein the three-dimensional model is associated with a first property and a second property; displaying a pad user-interface element, wherein the pad user-interface element includes an area for receiving a user selection; receiving a user selection of the pad user-interface element, the user selection being associated with an first axis coordinate and a second axis coordinate; changing the value of the first property based on the first axis coordinate; changing the value of the second property based on the second axis coordinate; and modifying the appearance of the three-dimensional model in a first manner based on the change to a value of the first property and in a second manner based on the change to a value of the second property.

### CROSS-REFERENCE TO RELATED APPLICATIONS

This application is related to U.S. patent applications Ser. No. 13/927,822, filed on Jun. 26, 2013; and Ser. No. 14/179,020, filed on Feb. 12, 2014, the entire disclosures of which are hereby incorporated herein by reference for all purposes.

### TECHNICAL FIELD

Various exemplary embodiments disclosed herein relate generally to digital models, simulations, and presentations.

### BACKGROUND

Medical environments may be used to help describe or communicate information such as chemical, biological, and physiological structures, phenomena, and events. Until recently, traditional medical environments have consisted of drawings or polymer-based physical structures. However, because such models are static, the extent of description or communication that they may facilitate is limited. While some drawing models may include multiple panes and while some physical models may include colored or removable components, these models are poorly suited for describing or communicating dynamic chemical, biological, and physiological structures or processes. For example, such models poorly describe or communicate events that occur across multiple levels of organization, such as one or more of atomic, molecular, macromolecular, cellular, tissue, organ, and organism levels of organization, or across multiple structures in a level of organization, such as multiple macromolecules in a cell.

### SUMMARY

A brief summary of various exemplary embodiments is presented below. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various embodiments described herein relate to a non-transitory machine-readable storage medium encoded with instructions for execution by a processor, the medium including: instructions for displaying a three-dimensional model, wherein the three-dimensional model is associated with a first property and a second property; instructions for modifying the appearance of the three-dimensional model in a first manner based on a change to a value of the first property and in a second manner based on a change to a value of the second property; instructions for displaying a pad user-interface element, wherein the pad user-interface element includes an area for receiving a user selection; instructions for receiving a user selection of the pad user-interface element, the user selection being associated with an first axis coordinate and a second axis coordinate; instructions for changing the value of the first property based on the first axis coordinate; and instructions for changing the value of the second property based on the second axis coordinate.

Various embodiments described herein relate to a simulation device including: a display device; an input device; a memory; and a processor configured to: cause the display device to display a three-dimensional model, wherein the three dimensional model is associated with a first property and a second property, modify the appearance of the three-dimensional model in a first manner based on a change to a value of the first property and in a second manner based on a change to a value of the second property, cause the display device to display a pad user-interface element, wherein the pad user-interface element includes an area for receiving a user selection, receive, via the input device, a user selection of the pad user-interface element, the user selection being associated with a first axis coordinate and a second axis coordinate, change the value of the first property based on the first axis coordinate, and change the value of the second property based on the second axis coordinate.

Various embodiments described herein relate to a method for displaying a simulation, the method including: displaying a three-dimensional model, wherein the three-dimensional model is associated with a first property and a second property; displaying a pad user-interface element, wherein the pad user-interface element includes an area for receiving a user selection; receiving a user selection of the pad user-interface element, the user selection being associated with an first axis coordinate and a second axis coordinate; changing the value of the first property based on the first axis coordinate; changing the value of the second property based on the second axis coordinate; and modifying the appearance of the three-dimensional model in a first manner based on the change to a value of the first property and in a second manner based on the change to a value of the second property.

Various embodiments are described wherein the instructions for displaying a three-dimensional model include instructions for displaying a plurality of three-dimensional models organized into a plurality of groups; the first property is a first positional offset between groups of the plurality of groups; and the second property is a second positional offset between three-dimensional models belonging to at least one group of the plurality of groups.

Various embodiments additionally include instructions for receiving a selection of a three-dimensional model of the plurality of three-dimensional models; and instructions for, in response to receiving the selection of the three-dimensional model, toggling visibility of the selected three-dimensional model.

Various embodiments additionally include instructions for receiving a selection of a three-dimensional model of the plurality of three-dimensional models; and instructions for, in response to receiving the selection of the three-dimensional model, isolating the display of the selected three-dimensional model away from other models of the plurality of three-dimensional models.

Various embodiments are described wherein: the first property is a degree of a first type of explosion used in displaying constituent parts the three-dimensional model; and the second property is a degree of a second type of explosion used in displaying constituent parts of the three-dimensional model.

Various embodiments are described wherein: the three-dimensional model is a simulation of an anatomical structure; the first property indicates a severity of a first condition associated with the anatomical structure; and the second property indicates a severity of a second condition associated with the anatomical structure.

Various embodiments additionally include instructions for displaying an icon within the area at a location corresponding to a previous user selection.

### BRIEF DESCRIPTION OF THE DRAWINGS

In order to better understand various exemplary embodiments, reference is made to the accompanying drawings, wherein:

FIG. 1 illustrates an exemplary hardware device for providing a simulation;

FIG. 2 illustrates an exemplary user interface for displaying a simulation in connection with a pad UI element;

FIG. 3 illustrates an exemplary user interface for displaying a simulation after receiving user input via a pad UI element;

FIG. 4 illustrates an exemplary method for receiving and processing user input via a pad UI element;

FIG. 5 illustrates an exemplary user interface for navigating a complex model simulation;

FIG. 6 illustrates an exemplary user interface for displaying multiple groups of a complex model simulation;

FIG. 7 illustrates an exemplary user interface for navigating a complex model simulation after user toggling of multiple groups of the model simulation;

FIG. 8 illustrates an exemplary user interface for displaying multiple individual model simulations of a complex model simulation;

FIG. 9 illustrates an exemplary user interface for navigating a complex model simulation after user toggling of multiple individual models of a complex model simulation; and

FIG. 10 illustrates an exemplary method for navigating a complex model simulation.

### DETAILED DESCRIPTION

Referring now to the drawings, in which like numerals refer to like components or steps, there are disclosed broad aspects of various exemplary embodiments. The term, “or,” as used herein, refers to a non-exclusive or (i.e., and/or), unless otherwise indicated (e.g., “or else” or “or in the alternative”). It will be understood that the various embodiments described herein are not necessarily mutually exclusive, as some embodiments may be combined with one or more other embodiments to form new embodiments.

As will be described in greater detail below, various embodiments described herein use a “pad” user interface (UI) element for receiving user input for use in modifying a displayed model simulation. In various embodiments, the pad UI element is displayed as part of a graphical user interface to denote region of the screen that is isolated to perform a function that is different from the rest of the screen. For example, where the device includes a touch screen (e.g., where the device is a tablet), the pad UI element area may be used to modify properties of the model simulation while the rest of the screen that is not otherwise isolated by a UI control may be used for rotation of the model simulation. In particular, when a user selects the pad UI element, the two coordinates of the selection may be used to set two different properties of the displayed model. In this manner, multiple user interface elements (e.g., two separate sliders) may be replaced with a single, intuitive control. In some embodiments, such a control may be used to navigate through a complex model (e.g., a model of a human body) with agility.

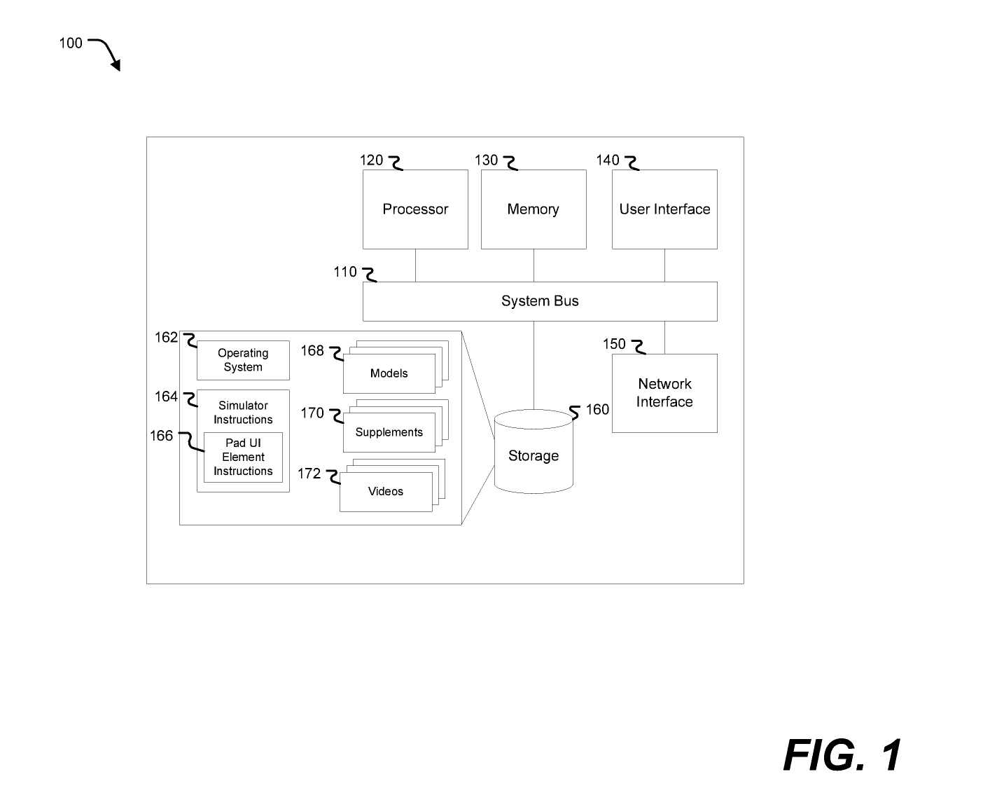

FIG. 1 illustrates an exemplary hardware device 100 for providing a simulation. The device may be one or more of various devices such as, for example, a personal computer, tablet, smart phone, server, or blade. In some embodiments, the hardware device may constitute a specialized computer such as, for example, a computer for controlling or interfacing with medical devices such a MRI or other imaging machines, medical computers for transport between patient and other rooms, or non-medical devices such as rapid prototyping machines. Various additional specific applications and machines where it would be beneficial to implement the methods and arrangements described herein will be apparent. As shown, the hardware device 100 may include a processor 120, memory 130, user interface 140, network interface 150, and storage 160 interconnected via one or more system buses 1100. It will be understood that FIG. 1 constitutes, in some respects, and abstraction and that the actual organization of the components of the hardware device 100 may be more complex than illustrated.

The processor 120 may be any hardware device capable of executing instructions stored in memory 130 or storage 160. As such, the processor may include a microprocessor, field programmable gate array (FPGA), application-specific integrated circuit (ASIC), or other similar devices.

The memory 130 may include various memories such as, for example L1, L2, or L3 cache or system memory. As such, the memory 130 may include static random access memory (SRAM), dynamic RAM (DRAM), flash memory, read only memory (ROM), or other similar memory devices.

The user interface 140 may include one or more devices for enabling communication with a user. For example, the user interface 140 may include a display and speakers for displaying video and audio to a user. As further examples, the user interface 140 may include a mouse, keyboard, or touch screen for receiving user commands and a microphone for receiving audio from the user. In some embodiments, the user interface 140 includes a graphical user interface, command line interface, or other interface for receiving user input over the network interface 150 from a remote user such as, for example, a user operating a thin client (e.g., on a smart phone or tablet).

The network interface 150 may include one or more devices for enabling communication with other hardware devices. For example, the network interface 150 may include a network interface card (NIC) configured to communicate according to the Ethernet protocol. Additionally, the network interface 150 may implement a TCP/IP stack for communication according to the TCP/IP protocols. Various alternative or additional hardware or configurations for the network interface 150 will be apparent.

The storage 160 may include one or more machine-readable storage media such as read-only memory (ROM), random-access memory (RAM), magnetic disk storage media, optical storage media, flash-memory devices, or similar storage media. In various embodiments, the storage 160 may store instructions for execution by the processor 120 or data upon with the processor 120 may operate. For example, the storage 160 is shown to store an operating system 162 for directing various basic functions of the device 100 such as, for example, input handling and graphics display via the user interface 140.

As shown, the storage 160 includes simulator instructions 164 which, as will be understood, load various models 168 and supplements 170 extending model functionality to present simulations to a user. For example, the simulator instructions 164 may use a model 168 of a heart and a supplement 170 defining a heart attack to present a simulation of a heart attack to a user. Various additional models 168 and supplements 170 for use in creating simulations will be apparent. In various embodiments, the simulator instructions 164 enable a user to graphically navigate through multiple models 168 or select one or more models 168 for display. The simulator instructions 164 may also enable a user to create videos 172 of simulations for later playback. In such embodiments, the simulator instructions 164 may be viewed as instructions defining a presentation creator or editor.

The simulator instructions 164 additionally include pad UI element instructions 166 for defining a UI pad element for receiving user input. As will be described in various examples below, the UI pad element may provide a single UI control for controlling multiple properties of a model. As such, the simulator instructions 164 may make use of the pad UI element instructions 166 in multiple and varied contexts. For example, the simulator instructions 164 may use the pad UI element instructions 166 to provide a pad UI element for use in navigating multiple models forming a human body and, subsequently, to provide a different pad UI element for use in controlling two properties of a heart (or other structure) model. Various additional and alternative uses for the pad UI element described herein will be apparent.

It will be apparent that various information described as stored in the storage 160 may be additionally or alternatively stored in the memory 130. In this respect, the memory 130 may also be considered to constitute a “storage device” and the storage 160 may be considered a “memory.” Various other arrangements will be apparent. Further, the memory 130 and storage 160 may both be considered to be “non-transitory machine-readable media.” As used herein, the term “non-transitory” will be understood to exclude transitory signals but to include all forms of storage, including both volatile and non-volatile memories.

While the host device 100 is shown as including one of each described component, the various components may be duplicated in various embodiments. For example, the processor 120 may include multiple microprocessors that are configured to independently execute the methods described herein or are configured to perform steps or subroutines of the methods described herein such that the multiple processors cooperate to achieve the functionality described herein. Further, where the device 100 is implemented in a cloud computing system, the various hardware components may belong to separate physical systems. For example, the processor 120 may include a first processor in a first server and a second processor in a second server.

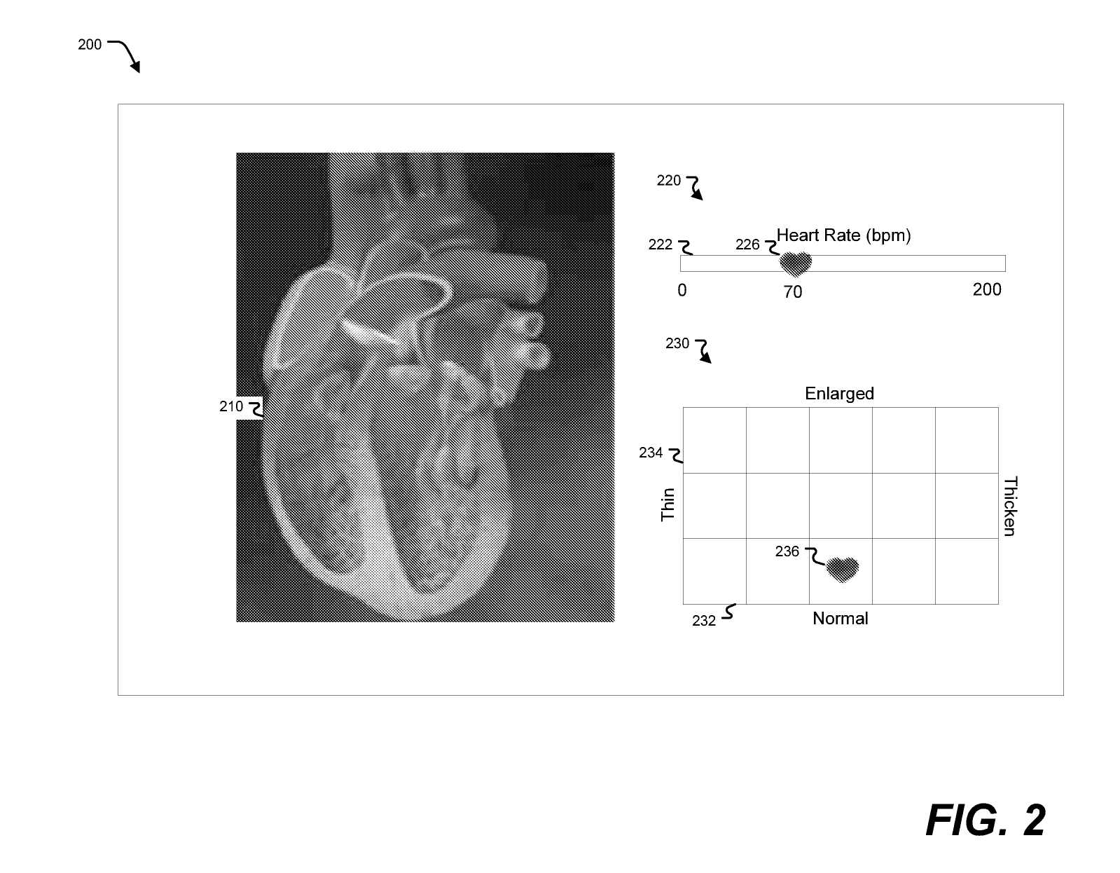

FIG. 2 illustrates an exemplary user interface 200 for displaying a simulation in connection with a pad UI element. As shown, the interface 200 includes a simulation of a heart 210 and two UI controls 220, 230 for controlling various properties of the heart simulation 210. Specifically, the UI controls 220, 230 enable the user to modify three properties: heart rate, wall thickness, and enlargement. Such properties may be provided by the underlying model or supplement. For example, the heart model itself may define a heart rate property while a heart disease supplement may define the wall thickness and enlargement properties.

The heart rate property is controlled by a classic “slider” UI element 220. The slider UI element 220 includes a horizontal bar 222 representing the range of values that may be assigned to the underlying property (in this case, heart rate) and an icon 226 or other indicator for specifying a currently selected value along this range. As shown, the icon 226 indicates that the current value for the underlying property is “70.” Using the slider UI element 220, a user may click (or touch) and drag the icon 226 along the bar 222 (or click/touch another location on the bar 222) to set a new value for the property. The heart simulation 210 would then be updated in view of the new value (e.g., by beating faster or slower based on the new heart rate value).

The wall thickness and enlargement properties are controlled by a pad UI element 230. The pad UI element includes a defined area bounded by an x-axis 232 and a y-axis 234 that each independently represent a range of values that may be assigned to one of the two properties. In other words, the x-axis 232 represents the range of values for the wall thickness property while the y-axis 234 represents a range of values for the enlargement property. As such, the axes of the pad UI element 230 may be bound to properties of the displayed simulation 210. An icon 236 or other indicator specifies currently selected values for the two properties. As shown, the icon 236 indicates that the enlargement property is at the “normal” end of the value range and that the wall thickness is at a midpoint between the “thin” and “thick” ends of the value range. The user may click (or touch) and drag the icon 236 within the area (or click/touch another location within the area) to produce a selection of two new values for the bound properties. In various embodiments, these two new values may be used simultaneously to update the displayed simulation, thereby allowing a user to simultaneously change the simulation in two different ways.

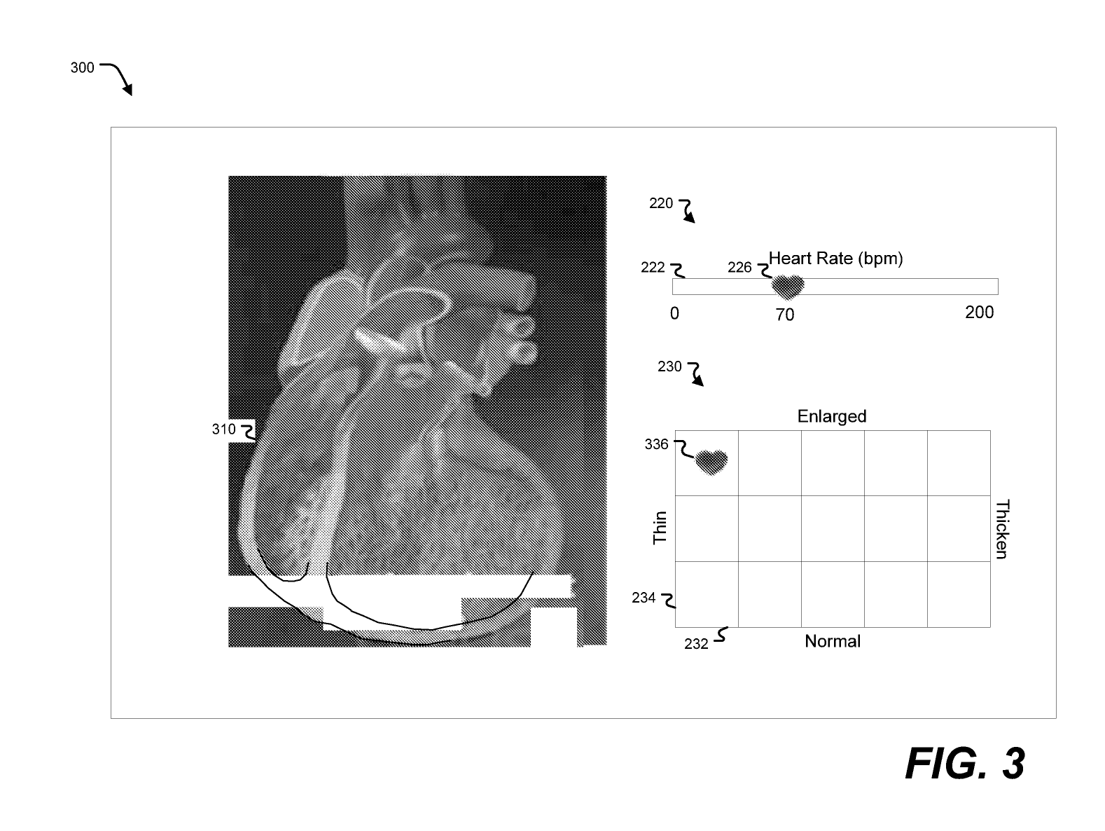

FIG. 3 illustrates an exemplary user interface 300 for displaying a simulation after receiving user input via a pad UI element. As shown, the user has placed the icon 336 in the upper left of the pad area, thereby indicating that the wall thickness property should be set to the value at the “thin” end of the value range and that the enlargement property should be set to the value at the “enlarged” end of the value range. In response, the heart simulation 310 is updated to simulate a heart that is both enlarged and has thinned walls. Other effects on the heat simulation 310 will be apparent based on placing the icon 336 at other areas within the pad UI element 230 area.

As shown, the pad UI element 230 area is divided into fifteen different areas. Such a display may be appropriate when the underlying properties may take on one of multiple discrete values. For example, where the enlargement property (as defined by the underlying model or supplement) has three possible values, the pad UI element 230 area may be divided into three rows representing each of these possible values. Similarly, where the wall thickness property has five possible values, the pad UI element 230 area may be divided into five columns, thereby producing fifteen total areas wherein the icon 336 may be placed. It will be apparent that in various alternative embodiments, such as embodiments wherein one or more of the underlying properties may carry values from a continuous range, such subdivisions may be absent. For example, if the wall thickness property were instead capable of being set to any value within a continuous range between two extremes (e.g., any integer value) the subdivisions along the x-axis 232 may be omitted, leaving an area with three rectangles within which the icon 336 may be slid to any point left and right.

It will be further apparent that the pad UI element 230 may be bound to more than two properties. For example, two different properties may be assigned to the X axis 232. The midpoint of the x-axis 232 may be taken as a minimum for both properties, the left side of the x-axis 232 may be taken as the maximum for the first property, and the right side of the x-axis 232 may be taken as the maximum for the second property. For example, such an arrangement may be used wherein wall thinning and thickening are controlled by two different properties. In such an embodiment, the x-axis 232 may be bound to both a “wall thinness” property and a “wall thickness” property. When the icon 336 is placed left of center, the thinness property may be set based on the icon position while the thickness property may be set to a value of 0 (or some other value indicating that no thickening should be applied). Similarly, when the icon 336 is placed right of center, the thickness property may be set based on the icon position while the thinness may be set to a value of 0 (or some other value indicating that no thinning should be applied). Various additional modifications will be apparent.

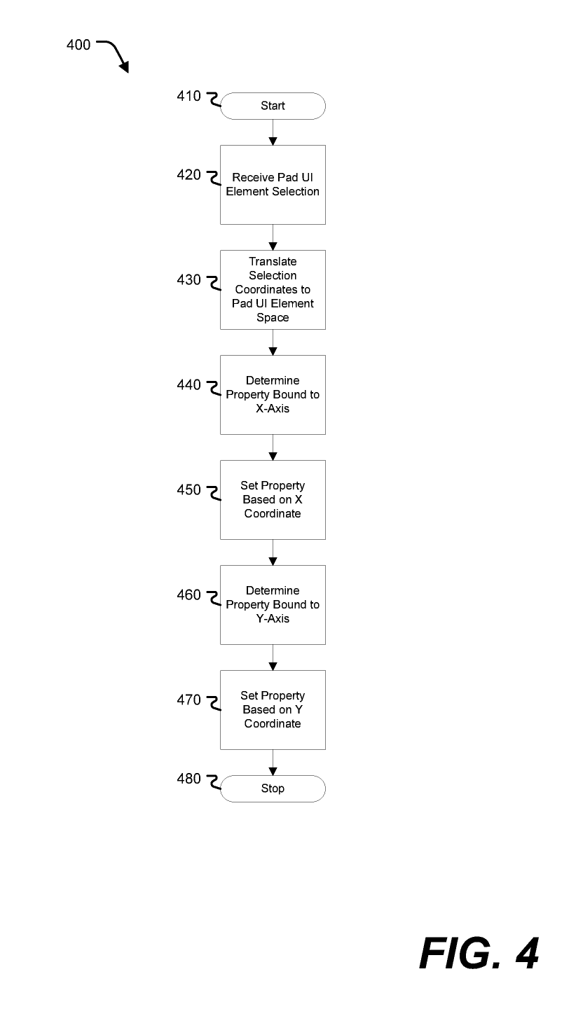

FIG. 4 illustrates an exemplary method 400 for receiving and processing user input via a pad UI element. The method 400 may correspond to the pad UI instructions 166 of the exemplary hardware device 100 and may be executed may a processor.

The method 400 begins in step 410 and proceeds to step 420 where the processor receives a selection of the UI pad element. As will be understood, the selection of the UI pad element may in various embodiments constitute various groupings of the following: clicking (or touching) within the area of the UI pad element, clicking (or touching) the icon of the UI pad element, dragging the icon of the UI pad element to a new location, or releasing the icon of the UI pad element at a new location. For example, in embodiments that update a simulation properties in real time as the user drags the icon, a selection may be received on each execution of an update loop while the user is “holding” or dragging the icon. In other embodiments wherein the simulation is not updated until the user releases the icon, a pad UI element selection may only be received when the user clicks the pad UI element area or releases the dragged icon.

After receiving a user selection, the method 400 proceeds to step 430 where the processor translates the coordinates of the selection to pad UI element space. Specifically, in some embodiments, the selection received in step 420 may be associated with coordinates (e.g., where the icon was dropped or where the user clicked/touched) that are expressed in screen (or other) space. In such embodiments, the processor translates the received coordinates into coordinates that relate to the axes displayed for the pad UI element. In some embodiments, the received selection may already be expressed in pad UI element space, in which case step 430 may be omitted or skipped.

In step 440, the processor determines a property that is bound to the x-axis of the pad UI element. For example, a lookup table or other data structure may maintain correspondences between pad UI element axes and properties bound thereto. As another example, an instantiated object representative of the pad UI element may store a pointer or other indication of a property associated with the x-axis (and y-axis). As yet another example, the pad UI element may be hardcoded to bind the axes to specific properties. Various additional and alternative methods for binding properties to the pad UI element axes will be apparent.

Next, in step 450, the processor sets the property bound to the x-axis based on the x coordinate of the user selection. For example, in some embodiments, the processor may simply set the property equivalent to the value of the x-coordinate. In other embodiments, the processor may translate the x-coordinate to an appropriate value for the property. For example, where the property may take on any value in a continuous range, the processor may calculate a value between the minimum and maximum values that corresponds to the x coordinate. As another example, where the property may take on one of a finite set of discrete values, the processor may determine within which subdivision of the pad area the x coordinate falls and set the property to the discrete value corresponding to that subdivision. Various additional and alternative methods for translating an x coordinate to a property value will be apparent.

The processor goes on, in steps 460 and 470, to determine a property bound to the y-axis and set the property based on the y coordinate of the selection. Steps 460 and 470 may be similar to those described above with respect to steps 440 and 450. In various embodiments, while similar, steps 460 and 470 are independent of steps 440 and 450. For example, the properties set in step 450 and 470 may be different from and independent of each other. As another example, step 450 may translate a coordinate to a value on a continuous range while step 470 may translate a coordinate to a value from a finite set of discrete values. Various alternative arrangements and configurations will be apparent.

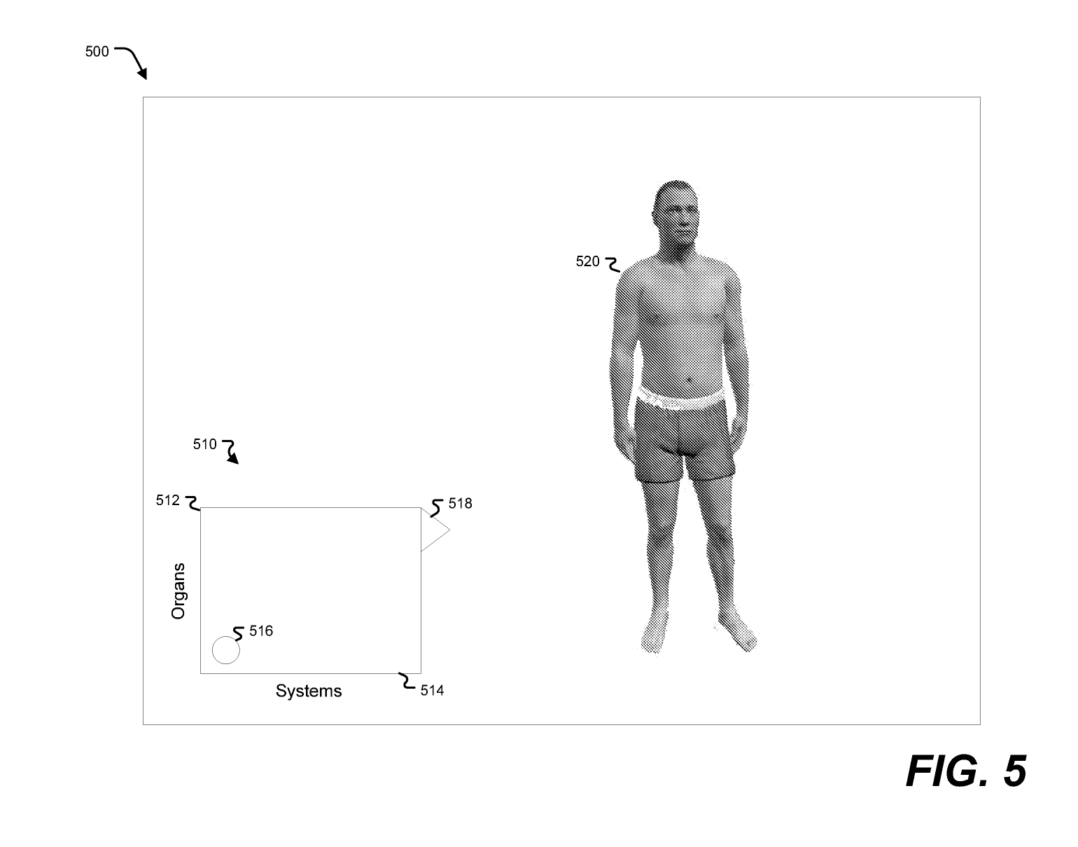

As another example of a use for a pad UI element, such a UI element may be used to facilitate navigation through a “complex model simulation” that includes multiple potential points of interest and may not easily be fully understood by a viewer from a single view. FIG. 5 illustrates an exemplary user interface 500 for navigating a complex model simulation. As shown, the interface 500 includes a pad UI element 510 and a complex model simulation 520. The complex model simulation is a simulation of a human anatomy and may include multiple model simulations of anatomical systems, organs, and other structures, all of which may not be visible in a current view. In various embodiments, the user may change the view of the model simulation 520 by, for example, clicking (or touching) and dragging to rotate the model simulation 520 in three dimensional space. Further, additional controls may be displayed for interacting with the model simulation in manners other than those described herein.

The pad UI element 510 may be provided to facilitate changing various “explosion” levels of the complex model 520. Specifically, the x-axis 514 may be used to create an exploded view of the systems forming the model 520 while the y-axis may be used to create an exploded view of organs forming one or more of the systems within the model 520. An icon 516 indicates a currently set value for these properties and a saved views icon 518 is provided to access a menu for saving and restoring views of the model simulation 520, as will be described in greater detail below.

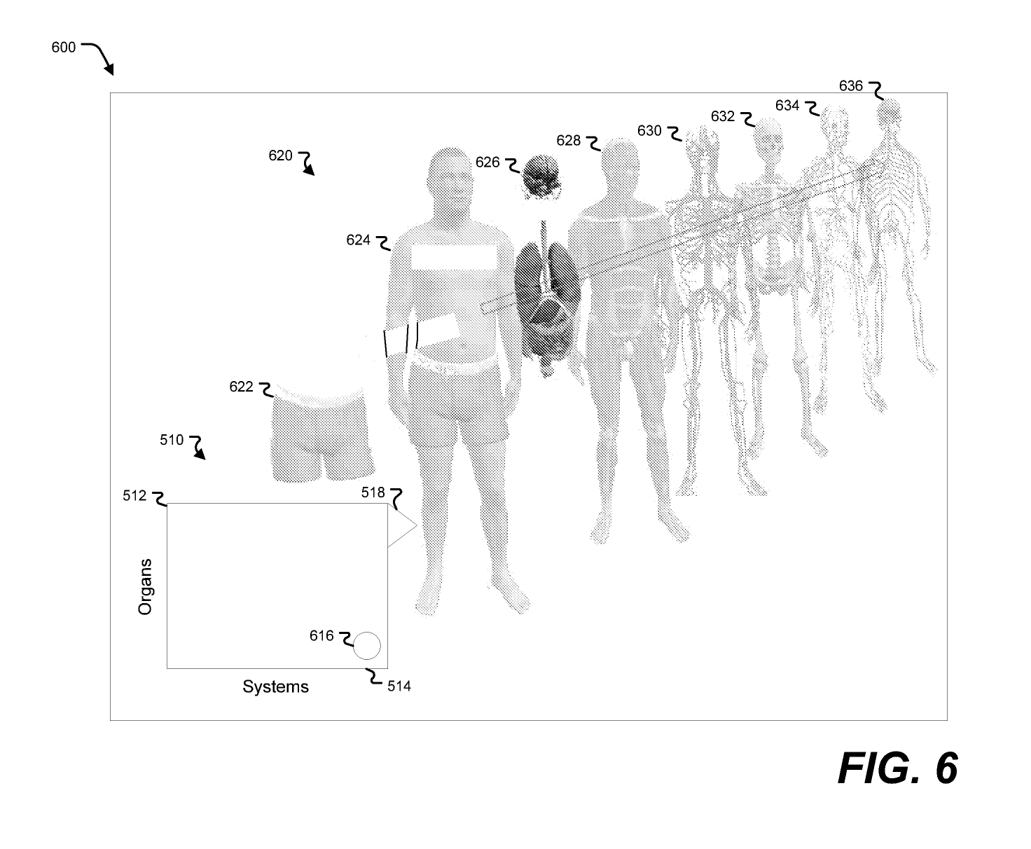

FIG. 6 illustrates an exemplary user interface 600 for displaying multiple groups of a complex model. As shown, the user has moved the icon 616 to the right along the x-axis 514 of the pad UI element 510. As such, the offset between the various systems of models forming the complex model 620 has been increased, thereby rendering the systems 622, 624, 626, 628, 630, 632, 634, 636 visible apart from each other. As shown, the systems 622, 624, 626, 628, 630, 632, 634, 636 each include one or more model simulations that are deemed to belong to a particular group of the human anatomy. For example, the muscular system 628 includes one or more model simulations of muscles while the skeletal system 632 includes one or more model simulations of bones.

From this user interface 600, the user may be able to select and deselect systems for display once the complex model simulation is reconstituted through use of the pad UI element 510. For example, as shown, the organs system 626 is currently displayed as toggled on by virtue of its display in full color or non-shadowed form. Conversely, the remaining systems 622, 624, 628, 630, 632, 634, 636 are displayed as toggled off by virtue of their display in non-color or shadowed form. Upon clicking (or touching) systems 622 and 630, the display would be updated to toggling these systems 622, 630 on for display in the reconstituted complex model simulation.

As will be understood and as previously described with respect to interface 500, various additional controls may be available in this and the remaining interfaces to be discussed. For example, the user may be able to rotate, pan, zoom, or affect other properties of the simulation 620 through additional UI elements (not shown), clicking (or touching) and dragging, or performing other gestures. For example, an additional pad UI element (not shown) may be provided to control the rotation of the model simulation 620 in two planes.

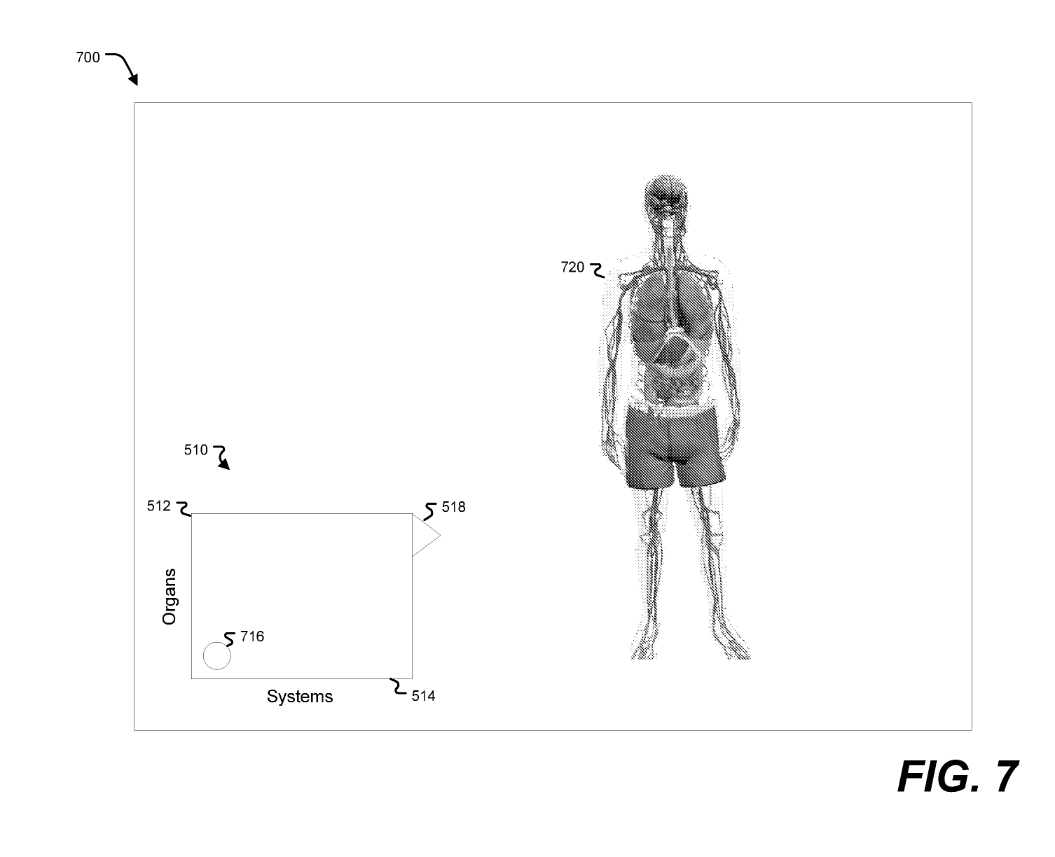

FIG. 7 illustrates an exemplary user interface 700 for navigating a complex model after user toggling of multiple groups of the model. After selecting and deselecting systems for display, the user may reconstitute the assembled model by moving the icon 716 back to the lower left of the pad UI element 510, as shown. As such, the explosion is reversed and the offset between the system models is reduced to zero (or otherwise, not offset) such that the systems are recombined into the model simulation 720 shown. Through selection of systems 622, 626, and 630 in the exploded view of interface 600, the reconstituted model 720 is shown to display only the models that belong to those systems.

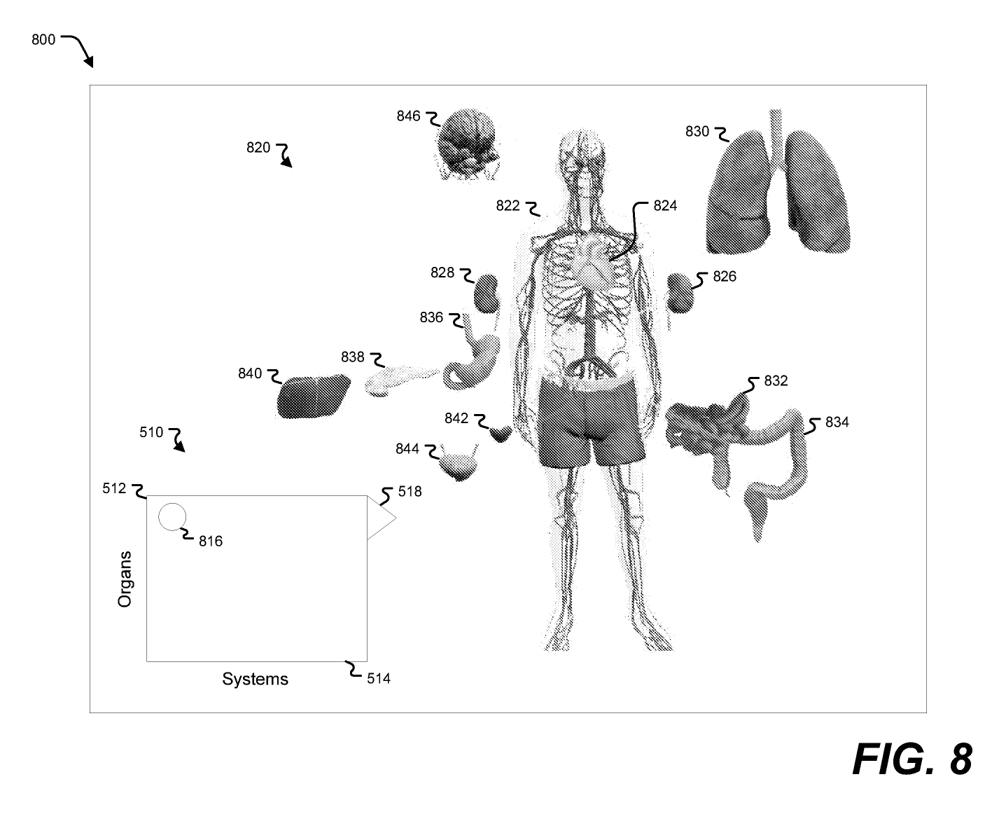

To provide a different level of granularity, the y-axis of the pad UI element 512 may be provided to explode the displayed model simulations at a different organization level. For example, the y-axis 512 may be bound to an offset between individual model simulations of the complex model simulation 720. FIG. 8 illustrates an exemplary user interface 800 for displaying multiple individual model simulations of a complex model simulation. As shown, the user has moved the icon 816 to the upper left corner to maximize the offset between the individual model simulations. The resulting display of the model simulation 820 includes model simulations of individual organs 824, 826, 828, 830, 832, 834, 836, 838, 840, 842, 844, 846 offset from the rest of the model simulation 822. As shown, one model simulation 824 remains at the center of the other system model simulations 822 as an anchor.

From this view, the user may click or touch individual model simulations 822, 824, 826, 828, 830, 832, 834, 836, 838, 840, 842, 844, 846 to toggle these model simulations for inclusion in the reconstituted complex model simulation. For example, the user may toggle the model simulations such that only the kidneys 826, 828 and bladder 844 are selected for display. In some embodiments, while they are displayed separately, the kidneys 826, 828 may be selected and deselected as a unit.

As shown, the x-axis 512 is tied to the offset of individual models within only the organ system 626 arrangement level (as shown in FIG. 6). In other words, the pad UI element 512 is not shown as being configured to cause explosion of for example, individual muscles (or groupings thereof) or bones (or groupings thereof). It will be appreciated that the systems may described herein may be modified to achieve such functionality. For example, the y-axis 512 may be bound to the offset of all individual model simulations or all individual model simulations that are currently toggled to active. Alternatively, additional UI elements (e.g., additional pad UI elements) may be provided and bound separately to the individual model simulations in each grouping. As yet another alternative, a selector may be provided to change the group whose individual model simulations are controlled by the y-axis 512. As another alternative, more than one pad UI element could be activated on a screen. For example, when the organs are exploded, a single organ may be selected by the user and this selection may activate the appearance of a second pad UI element, which could drive alteration of the selected organ. For example, the selected organ could itself be exploded on two axes or, its appearance may be modified. For example, the organ may be given a level of transparency simultaneous with an alteration in the appearance of an outline of the organ's internal and external shapes. Various additional arrangements will be apparent.

In addition to the controls described above with respect to the previous interfaces 500, 600, 700, a user may be provided the ability to isolate individual model systems. For example, by double clicking (or double tapping) on a kidney simulation 826, 828, the interface 800 may isolate the kidney model simulation by removing the other model simulations or by replacing the current kidney simulations 826, 828 with a more detailed model simulation. Similar functionality may be implemented on a system-by-system basis. For example, by double clicking (or double tapping) on the nervous system model simulation group 636 on interface 600, the nervous system model simulation group 636 may be similarly isolated from the other systems.

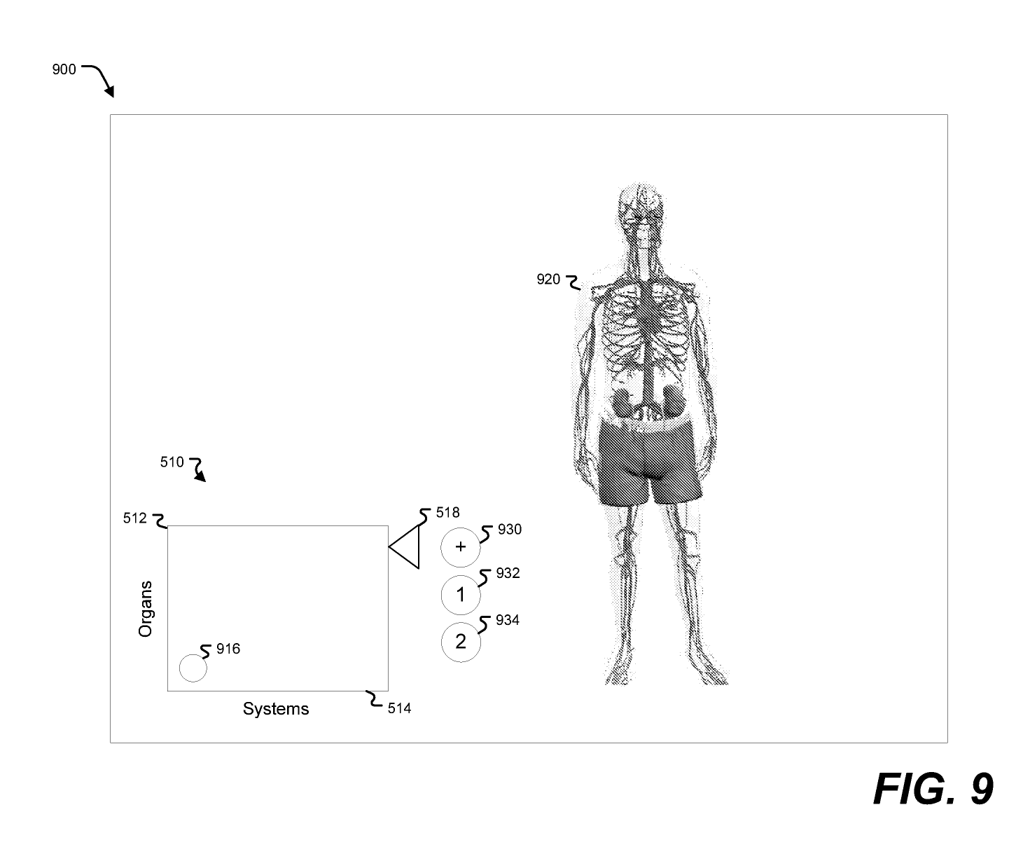

FIG. 9 illustrates an exemplary user interface 900 for navigating a complex model after user toggling of multiple individual models of a complex model. Upon moving the icon 916 back to the lower left of the pad UI element 510, the offsets between the individual model simulations is decreased to zero (or no offset) such that the complex model simulation is reconstituted 920. As shown, the model simulation 920 displays only those systems and individual model simulations that were selected for display on interfaces 600 and 800.

As will be understood, various alternative arrangements may be produced by the pad UI element 512. For example, less extreme explosion may be effected by setting the icon 516 at a point other than one of the axis extremes. Further, both types of explosion may simultaneously be effected by moving the icon 516 to a point that is non-zero on both axes.

As further shown, the saved views icon 518 has been selected and, consequently, a saved views menu of one or more buttons 930, 932, 934 is displayed. By clicking the save view button 930, the current view (e.g., selected systems and individual model simulations, rotation, zoom, pan, etc.) may be saved as a new button (not shown) for later loading. By clicking one of the load view buttons 932, 934 a previously saved view may be loaded to replace the current view. In this manner, views may be saved for later easy loading, e.g., for a patient during patient visit. Alternatively, instead of saving a simple view, each of the movements that a user has made may be saved in a sequence, such that the sequence of movements may be “played back” for a viewer. For example, the “view” may be saved and loaded as a macro to reproduce the original simulation within the simulator.

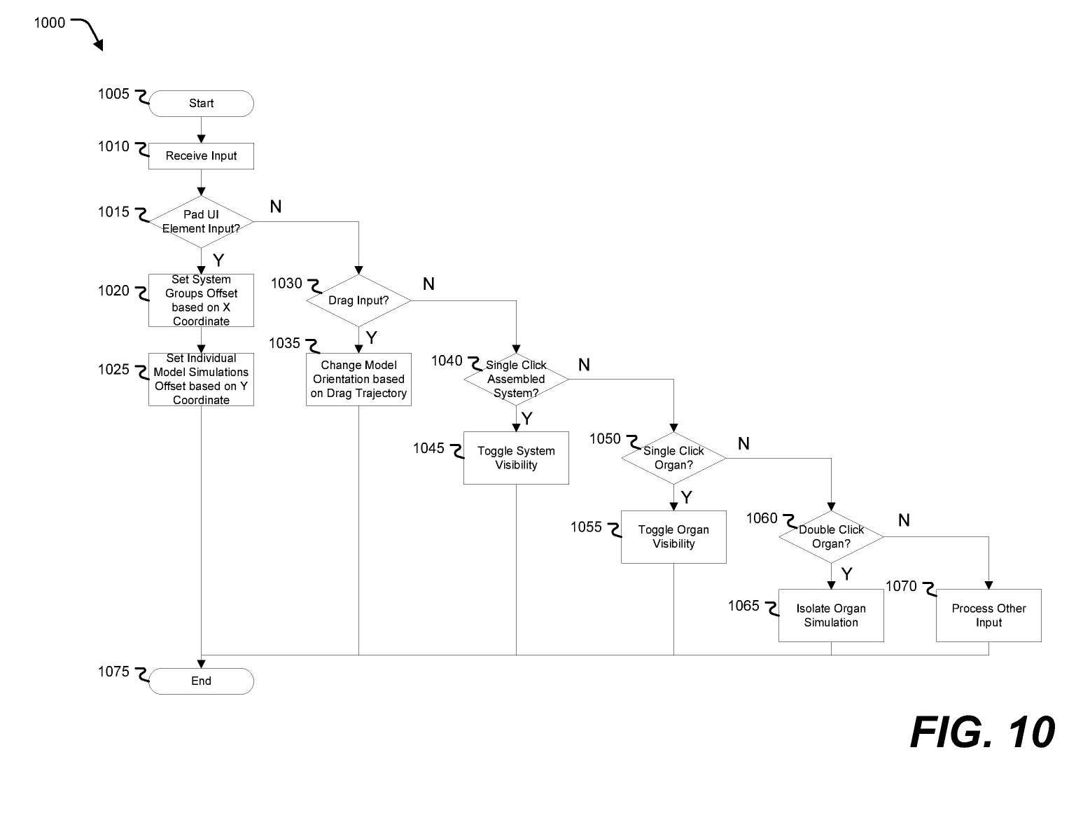

FIG. 10 illustrates an exemplary method 1000 for navigating a complex model. The method 1000 may correspond to the pad UI instructions 166 of the exemplary hardware device 100 and may be executed may a processor.

The method begins in step 1005 and proceeds to step 1010 where the processor receives input from the user. The processor then begins to interpret and process the input by first, in step 1015, determining whether the input is a selection of the pad UI element. If so, the processor proceeds to set the offset of the system groups based on the x coordinate of the selection in step 1020 and sets the offset of the individual model simulations based on the y coordinate of the selection in step 1025. These steps may correspond, for example, to one or more of the steps of method 400. The method 1000 then proceeds to end in step 1025.

If the input is not a selection of a pad UI element, however, the method 1000 proceeds from step 1015 to step 1030 where the processor determines whether the input is a click (or touch) and drag input. If so, the processor changes the model orientation based on the drag trajectory (e.g., direction and magnitude) in step 1035 and the method 1000 proceeds to end in step 1075.

If the input is not a drag input, the method 1000 proceeds to step 1040 where the processor determines whether the input is a single click (or tap) of an assembled system. If so, the processor toggles visibility of the selected system in step 1045 and the method 1000 proceeds to end in step 1075.

If the input is not a single tap of an assembled system, the method 1000 proceeds to step 1050 where the processor determines whether the input is a single click (or tap) of an organ. If so, the processor toggles visibility of the selected organ model simulation in step 1055 and the method 1000 proceeds to end in step 1075.

If the input is not a single tap of an organ model simulation, the method 1000 proceeds to step 1060 where the processor determines whether the input is a double click (or tap) of an organ. If so, the processor isolates selected organ model simulation in step 1065 and the method 1000 proceeds to end in step 1075. For example, the processor may remove other model simulations from view or may load a more detailed model simulation corresponding to the selected organ.

If the input is not a double tap of an organ model simulation, the method 1000 proceeds to step 1070 where the processor further interprets and processes the input in a manner similar to that described. For example, the processor may interpret gesture input or selection of other UI control elements to effect changes such as panning, zooming, recording of video, modification of other simulation properties, etc. The method then proceeds to end in step 1075.

In view of the foregoing, various embodiments provide a new pad UI element that simplifies various UI actions such as modifying multiple simulation properties or navigation of complex model simulations. Various additional benefits and applications will be apparent in view of the foregoing.

It will be understood that the various systems and methods described herein may be applicable to fields outside of medicine. For example, the systems and methods described herein may be adapted to other models such as, for example, mechanical, automotive, aerospace, traffic, civil, or astronomical systems. Further, various systems and methods may be applicable to fields outside of demonstrative environments such as, for example, video gaming, technical support, or creative projects. Various other applications will be apparent.

It should be apparent from the foregoing description that various exemplary embodiments of the invention may be implemented in hardware or software running on a processor. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a tangible and non-transitory machine-readable storage medium may include read-only memory (ROM), random-access memory (RAM), magnetic disk storage media, optical storage media, flash-memory devices, and similar storage media. Further, as used herein, the term “processor” will be understood to encompass a microprocessor, field programmable gate array (FPGA), application-specific integrated circuit (ASIC), or any other device capable of performing the functions described herein.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications may be effected while remaining within the spirit and scope of the invention. Accordingly, the foregoing disclosure, description, and figures are for illustrative purposes only and do not in any way limit the invention, which is defined only by the claims.

1. A non-transitory machine-readable storage medium encoded with instructions for execution by a processor, the medium comprising:
instructions for displaying a three-dimensional model, wherein the three-dimensional model is associated with a first property and a second property;
instructions for modifying the appearance of the three-dimensional model in a first manner based on a change to a value of the first property and in a second manner based on a change to a value of the second property;
instructions for displaying a pad user-interface element, wherein the pad user-interface element includes an area for receiving a user selection;
instructions for receiving a user selection of the pad user-interface element, the user selection being associated with an first axis coordinate and a second axis coordinate;
instructions for changing the value of the first property based on the first axis coordinate; and
instructions for changing the value of the second property based on the second axis coordinate.

2. The non-transitory machine-readable storage medium of claim 1, wherein
the instructions for displaying a three-dimensional model comprise instructions for displaying a plurality of three-dimensional models organized into a plurality of groups;
the first property is a first positional offset between groups of the plurality of groups; and
the second property is a second positional offset between three-dimensional models belonging to at least one group of the plurality of groups.

3. The non-transitory machine-readable storage medium of claim 2, further comprising:
instructions for receiving a selection of a three-dimensional model of the plurality of three-dimensional models; and
instructions for, in response to receiving the selection of the three-dimensional model, toggling visibility of the selected three-dimensional model.

4. The non-transitory machine-readable storage medium of claim 2, further comprising:
instructions for receiving a selection of a three-dimensional model of the plurality of three-dimensional models; and
instructions for, in response to receiving the selection of the three-dimensional model, isolating the display of the selected three-dimensional model away from other models of the plurality of three-dimensional models.

5. The non-transitory machine-readable storage medium of claim 1, wherein:
the first property is a degree of a first type of explosion used in displaying constituent parts the three-dimensional model; and
the second property is a degree of a second type of explosion used in displaying constituent parts of the three-dimensional model.

6. The non-transitory machine-readable storage medium of claim 1, wherein:
the three-dimensional model is a simulation of an anatomical structure;
the first property indicates a severity of a first condition associated with the anatomical structure; and
the second property indicates a severity of a second condition associated with the anatomical structure.

7. The non-transitory machine-readable storage medium of claim 1, further comprising instructions for displaying an icon within the area at a location corresponding to a previous user selection.

8. A simulation device comprising:
a display device;
an input device;
a memory; and
a processor configured to:
cause the display device to display a three-dimensional model, wherein the three dimensional model is associated with a first property and a second property,
modify the appearance of the three-dimensional model in a first manner based on a change to a value of the first property and in a second manner based on a change to a value of the second property,
cause the display device to display a pad user-interface element, wherein the pad user-interface element includes an area for receiving a user selection,
receive, via the input device, a user selection of the pad user-interface element, the user selection being associated with a first axis coordinate and a second axis coordinate,
change the value of the first property based on the first axis coordinate, and
change the value of the second property based on the second axis coordinate.

9. The device of claim 8, wherein:
in causing the display device to display the three-dimensional model, the processor is configured to cause the display device to display a plurality of three-dimensional models organized into a plurality of groups;
the first property is a first positional offset between groups of the plurality of groups; and
the second property is a second positional offset between three-dimensional models belonging to at least one group of the plurality of groups.

10. The device of claim 9, wherein the processor is further configured to:
receive a selection of a three-dimensional model of the plurality of three-dimensional models; and
in response to receiving the selection of the three-dimensional model, toggle visibility of the selected three-dimensional model.

11. The device of claim 9, wherein the processor is further configured to:
receive a selection of a three-dimensional model of the plurality of three-dimensional models; and
in response to receiving the selection of the three-dimensional model, isolate the display of the selected three-dimensional model away from other models of the plurality of three-dimensional models.

12. The device of claim 8, wherein:
the first property is a degree of a first type of explosion used in displaying constituent parts the three-dimensional model; and
the second property is a degree of a second type of explosion used in displaying constituent parts of the three-dimensional model.

13. The device of claim 8, wherein:
the three-dimensional model is a simulation of an anatomical structure;
the first property indicates a severity of a first condition associated with the anatomical structure; and
the second property indicates a severity of a second condition associated with the anatomical structure.

14. The device of claim 8, wherein the processor is further configured to cause the display device to display an icon within the area at a location corresponding to a previous user selection.

15. A method for displaying a simulation, the method comprising:
displaying a three-dimensional model, wherein the three-dimensional model is associated with a first property and a second property;
displaying a pad user-interface element, wherein the pad user-interface element includes an area for receiving a user selection;
receiving a user selection of the pad user-interface element, the user selection being associated with an first axis coordinate and a second axis coordinate;
changing the value of the first property based on the first axis coordinate;
changing the value of the second property based on the second axis coordinate; and
modifying the appearance of the three-dimensional model in a first manner based on the change to a value of the first property and in a second manner based on the change to a value of the second property.

16. The method of claim 15, wherein
displaying a three-dimensional model comprises displaying a plurality of three-dimensional models organized into a plurality of groups;
the first property is a first positional offset between groups of the plurality of groups; and
the second property is a second positional offset between three-dimensional models belonging to at least one group of the plurality of groups.

17. The method of claim 16, further comprising:
receiving a selection of a three-dimensional model of the plurality of three-dimensional models; and
in response to receiving the selection of the three-dimensional model, toggling visibility of the selected three-dimensional model.

18. The method of claim 16, further comprising:
receiving a selection of a three-dimensional model of the plurality of three-dimensional models; and
in response to receiving the selection of the three-dimensional model, isolating the display of the selected three-dimensional model away from other models of the plurality of three-dimensional models.

19. The method of claim 15, wherein:
the first property is a degree of a first type of explosion used in displaying constituent parts the three-dimensional model; and
the second property is a degree of a second type of explosion used in displaying constituent parts of the three-dimensional model.

20. The method of claim 15, wherein:
the three-dimensional model is a simulation of an anatomical structure;
the first property indicates a severity of a first condition associated with the anatomical structure; and
the second property indicates a severity of a second condition associated with the anatomical structure.
